(19) United States
(12) Patent Application Publication
(10) Pub. No.: US 2019/0074005 A1
(43) Pub. Date: Mar. 7, 2019

(54) Automated Conversation System and Method Thereof

(71) Applicant: ZENSAR TECHNOLOGIES LIMITED, Pune (IN)

(72) Inventor: Srinivasa Raju INDUKURI, Hyderabad (IN)

(21) Appl. No.: 16/122,342

(22) Filed: Sep. 5, 2018

(30) Foreign Application Priority Data
Sep. 6, 2017 (IN) 201721031604

(51) Int. Cl. G10L 15/22; G10L 15/18

(52) U.S. Cl. CPC G10L 15/22; G10L 2015/223; G10L 15/1822; G10L 15/1815

(57) ABSTRACT

The present disclosure envisages an automated conversation system for conversation to service mapping. The technical advantage of the present disclosure is to provide a conversation system for automatically adding a new service. The system comprising a user input module to receive a user input, a conversion engine to generate a machine input, a service repository to store a plurality of services and corresponding default actions, a service selection engine to select at least one service from the plurality of services, a service execution engine to execute the selected service and the corresponding default actions, a service addition module to receive a new service, and a service analyzer to analyzes the service to identify the corresponding default actions to the new service.

### FIELD

The present disclosure relates to the field of conversation systems.

### Definitions

As used in the present disclosure, the following terms are generally intended to have the meaning as set forth below, except to the extent that the context in which they are used indicates otherwise.

The expression ‘conversational interface’ used in the context of this disclosure refers to, but is not limited to, a user interface in which a user communicates with a computer.

The expression ‘services’ used in the context of this disclosure refers to, but is not limited to, digital services of an organizational function and a set of processes for identifying or creating, communicating, and delivering items to customers, and for managing customer relationship in a way that benefit the organization and stake-holders.

The expression ‘syntactic analysis’ used in the context of this disclosure refers to, but is not limited to, a process of analyzing a string of symbols conforming to the rules of formal grammar.

The expression ‘semantic analysis’ used in the context of this disclosure refers to, but is not limited to, a process of analyzing semantic structures, from the levels of phrases, clauses, sentences and paragraphs to the level of the writing as a whole, to their language-independent meanings.

These definitions are in addition to those expressed in the art.

### BACKGROUND

Typically, a conversational interface provides users to interact with service providers, in natural language. For instance, the service providers offer a list of services on their applications and/or websites. The users use their applications and/or websites for accessing the services. A representative present on the applications and/or websites (back end) sends the desired information to the user as a natural language message. The representative may be a virtual assistant that automatically identifies and provides the desired service/information to the user as a response. Many conversational systems have the virtual assistant that automatically identifies the desired information, and programmatically maps the information with services provided by the service providers, and send the response to the user. However, these systems require programming logic to be written to add a new service. Further, these systems are not adaptive to user preferences and prohibiting users from customizing the service invocation.

There is, therefore, felt a need to provide an automated conversation system that alleviates the above mentioned drawbacks.

### OBJECTS

Some of the objects of the present disclosure, which at least one embodiment herein satisfies, are as follows:

An object of the present disclosure is to provide an automated conversation system.

One object of the present disclosure is to provide an automated conversation system that automatically maps the conversation in natural language.

Another object of the present disclosure is to provide an automated conversation system that is highly reliable, adaptive, and customizable.

Still another of the present disclosure is to provide an automated conversation system that automatically adds a new service;

Yet another object of the present disclosure is to provide an automated conversation system that is simple and easy to operate.

Other objects and advantages of the present disclosure will be more apparent from the following description, which is not intended to limit the scope of the present disclosure.

### SUMMARY

The present disclosure envisages an automated conversation system for conversation to service mapping. The system comprising a user input module, a conversion engine, a service repository, a service selection engine, a service execution engine, and a service addition module.

The user input module is configured to receive a user input.

The conversion engine is configured to cooperate with the user input and is further configured to convert the user input to a machine input.

The service repository is configured to store a plurality of services and corresponding default actions.

The service selection engine is configured to cooperate with the conversion engine and the service repository to receive the machine input.

The service selection engine is further configured to select at least one service from the plurality of services based on the machine input.

The service execution engine is configured to cooperate with the service selection engine and configured to execute the selected service and the corresponding default actions. The service addition module is configured to receive a new service from an administrator.

The service analyzer is configured to cooperate with the service addition module to receive the new service and is further configured to analyze the service to identify corresponding default actions to the new service.

The user input module, the conversion engine, the service selection engine, the service execution engine, the service addition module, and the service analyzer are implemented using one or more processor(s).

In an embodiment, the new service and the corresponding actions is stored in the service repository.

In an embodiment, the automated conversation system further includes a user registration module and a user login module. The user registration module is configured to receive user details of the user. The user login module is configured to receive the login details of the user and is further configured to authenticate the user to facilitate the login of the user based on the user details.

In an embodiment, the system includes a customization engine. The customization engine is configured to facilitate the logged-in user to customize the corresponding default actions to the service stored in the service repository. The customization engine is implemented using one or more processor(s).

In an embodiment, the conversion engine performs semantic and syntactic analysis to convert the user input to generate the machine input.

In an embodiment, the user input is in the natural language.

In an embodiment, the machine input is in the machine language.

The present disclosure envisages an automated conversation method for conversation to service mapping comprising:
a. receiving, by a user input module, a user input;
b. converting, by a conversion engine, the user input to a machine input;
c. storing, in a service repository, a plurality of services and corresponding default actions;
d. receiving, by a service selection engine, the machine input and selecting at least one service from the plurality of services based on the machine input;
e. executing, by a service execution engine, the selected service and the corresponding default actions;
f. receiving, by a service addition module from an administrator; and
g. receiving, by a service analyzer, the new service and identifying corresponding default actions to the new service and storing the new service and the corresponding actions in the service repository.

In an embodiment, the automated conversation method further includes the step of facilitating the logged-in user to customize the corresponding default actions to the service stored in the service repository, by a customization engine.

### BRIEF DESCRIPTION OF THE ACCOMPANYING DRAWING

An automated conversation system and method thereof, of the present disclosure will now be described with the help of the accompanying drawing, in which:

FIG. 1 illustrates a schematic block diagram of an automated conversation system, in accordance with an embodiment of the present disclosure; and

FIG. 2 illustrates a flow diagram showing steps performed by the automated conversation system of FIG. 1, in accordance with an embodiment of the present disclosure.

### DETAILED DESCRIPTION

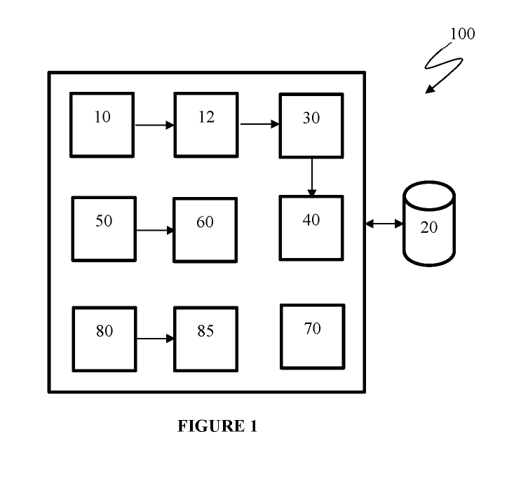

An automated conversation system will now be described with the help of accompanying drawing. FIG. 1 illustrates a schematic block diagram of the automated conversation system (100) (hereinafter referred to as ‘system’), in accordance with one embodiment of the present disclosure.

The system comprising a user input module (10), a conversion engine (12), a service repository (20), a service selection engine (30), a service execution engine (40), and a service addition module (50).

The user input module (10) is configured to receive a user input. In an embodiment, the user input is in the natural language.

The conversion engine (12) is configured to cooperate with the user input module (10) and is further configured to convert the user input to a machine input. In an embodiment, the conversion engine (12) performs semantic and syntactic analysis to convert the user input to the machine input. In an embodiment, the machine input is in the machine language.

The service repository (20) is configured to store a plurality of services and corresponding default actions.

The service selection engine (30) is configured to cooperate with the conversion engine (12) and the service repository (20) to receive the machine input. The service selection engine (30) is further configured to select at least one service from the plurality of services based on the machine input.

The service execution engine (40) is configured to cooperate with the service selection engine (30) to receive the selected service. The service execution engine (40) is further configured to execute the selected service and the corresponding default actions. A response generated by the execution of the selected service is provided to the user.

The service addition module (50) is configured to receive a new service from an administrator.

The service analyzer (60) is configured to cooperate with the service addition module (50) to receive the new service and is further configured analyze the new service to identify corresponding default actions to the new service. In an embodiment, the new service and the corresponding actions is stored in the service repository (20). In an embodiment, the service analyzer (60) is configured to analyze the new service to identify the default actions using at least one machine learning technique. The machine learning technique may be selected from the group consisting of a regression technique, a Gaussian process, a support vector machine (SVM), and a neuromorphic technique.

The user input module (10), the conversion engine (12), the service selection engine (30), the service execution engine (40), the service addition module (50), and the service analyzer (60) are implemented using one or more processor(s).

In an embodiment, the system (100) further includes a user registration module (80) and a user login module (85). The user registration module (80) is configured to receive user details of the user. The user login module (85) is configured to receive the login details of the user and is further configured to authenticate the user to facilitate the login of the user based on the user details.

In an embodiment, the system includes a customization engine (70). The customization engine (70) is configured to facilitate the logged-in user to customize the corresponding default actions to the service stored in the service repository (20). The customization engine (70) is implemented using one or more processor(s).

Table 1 illustrates an example of the user's input and service mapping.

| Map | | | | | |
|---|---|---|---|---|---|
| Type | user's input | Service | Action | Output | User |
| Default | PurchasePendingApprovals | Purchase.PendingApprovals | MinAmount <− | The Pending PO's are | Not |
| | | | InParameter.MinAmount | as following: | Applicable |
| | | | or 0 | *loop*[<Result.No>, | |
| | | | | <Result.Requestor>, | |
| | | | | <Result.Amount>] | |
| Custom | PurchasePendingApprovals | Purchase.PendingApprovals | MinAmount <− | The Pending PO's are | XYZ |
| | | | InParameter.MinAmount | as following: | |
| | | | or 100 | *loop*[<Result.No>, | |
| | | | | <Result.Requestor>, | |
| | | | | <Result.Amount>] | |

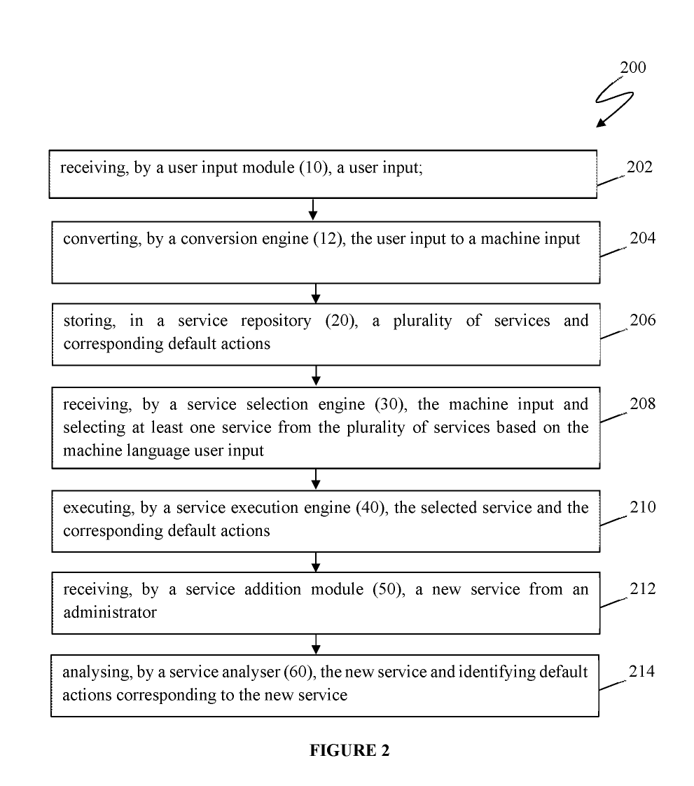

FIG. 2 illustrates a flow diagram (200) showing method steps performed by the automated conversation system (100), in accordance with an embodiment of the present disclosure.

At block 202, receiving, by a user input module (10), a user input.

At block 204, converting, by a conversion engine (12), the user input to a machine input.

At block 206, storing, in a service repository (20), a plurality of services and corresponding default actions.

At block 208, receiving, by a service selection engine (30), the machine input and selecting at least one service from the plurality of services based on the machine input.

At block 210, executing, by a service execution engine (40), the selected service and the corresponding default actions.

At block 212, receiving, by a service addition module (50), a new service from an administrator

At block 214, receiving, by a service analyzer (60), the new service and identifying corresponding default actions to the new service and storing the new service and the corresponding actions in the service repository (20).

In an embodiment, the automated conversation method (100) further includes the step of facilitating the logged-in user to customize the corresponding default actions to the service stored in the service repository (20), by a customization engine (70).

### Technical Advancements

The present disclosure described herein above has several technical advantages including, but not limited to, the realization of an automated conversation system and method thereof, that:

automatically maps the conversation in natural language;

automatically adds a new service;

that is highly reliable, adaptive, and customizable; and

is simple and easy to operate.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. An automated conversation system for conversation to service mapping comprising:
a. a user input module configured to receive a user input;
b. a conversion engine configured to cooperate with the user input module and further configured to convert the user input to a machine input;
c. a service repository configured to store a plurality of services and corresponding default actions;
d. a service selection engine configured to cooperate with the conversion engine and the service repository to receive the machine input and further configured to select at least one service from the plurality of services based on the machine input;
e. a service execution engine configured to cooperate with the service selection engine and further configured to execute the selected service and the corresponding default actions;
f. a service addition module configured to receive a new service from an administrator; and
g. a service analyzer configured to cooperate with the service addition module to receive the new service and further configured to analyse the service to identify corresponding default actions to the new service,
wherein the user input module, the conversion engine, the service selection engine, the service execution engine, the service addition module, and the service analyzer are implemented using one or more processor(s).

2. The system as claimed in claim 1, further includes:
a. a user registration module configured to receive user details of the user; and
b. a user login module configured to receive the login details of the user and further configured to authenticate the user to facilitate the login of the user based on the user details,
wherein the user registration module and the user login module are implemented using one or more processor(s).

3. The system as claimed in claim 1, which includes a customization engine configured to facilitate the logged-in user to customize the corresponding default actions to the service stored in the service repository, wherein the customization engine is implemented using one or more processor(s).

4. The system as claimed in claim 1, wherein the conversion engine performs semantic and syntactic analysis to convert the user input to the machine input.

5. The system as claimed in claim 1, wherein the new service and the corresponding actions is stored in the service repository.

6. The system as claimed in claim 1, wherein the user input is in the natural language.

7. The system as claimed in claim 1, wherein the machine input is in the machine language.

8. An automated conversation method for conversation to service mapping comprising:
a. receiving, by a user input module, a user input;
b. converting, by a conversion engine, the user input to a machine input;
c. storing, in a service repository, a plurality of services and corresponding default actions;
d. receiving, by a service selection engine, the machine input and selecting at least one service from the plurality of services based on the machine input;
e. executing, by a service execution engine, the selected service and the corresponding default actions;
f. receiving, by a service addition module, a new service from an administrator; and
g. analysing, by a service analyzer, the new service and identifying corresponding default actions to the new service.

9. The method as claimed in claim 8, further includes a step of facilitating a logged-in user to customize the corresponding default actions to the service stored in the service repository, by a customization engine.
